(19) United States
(12) Patent Application Publication
(10) Pub. No.: US 2026/0208873 A1
(43) Pub. Date: Jul. 23, 2026

(54) A SYSTEM AND METHOD FOR AN AIRPLANE

(71) Applicant: HEART AEROSPACE AB, Göteborg (SE)

(72) Inventors: Luis Antonio AGUILERA MEDINA, Göteborg (SE); Bassem FARAG, Hisings Kärra (SE); Fabrício DE OLIVEIRA SPIGOLON, Kungälv (SE)

(21) Appl. No.: 19/103,454

(22) PCT Filed: Aug. 18, 2023
(86) PCT No.: PCT/EP2023/072821

§ 371 Date: Feb. 12, 2025

(30) Foreign Application Priority Data
Aug. 19, 2022 (SE) 2250982-2

(51) Int. Cl. B64D 31/10; B64D 27/34; B64D 27/35; B64D 31/16; B64D 41/00; B64D 43/00; B64D 45/00; H02J 3/001

(52) U.S. Cl. CPC B64D 31/10; B64D 27/34; B64D 27/35; B64D 31/16; B64D 41/00; B64D 43/00; B64D 45/00; H02J 3/001; B64D 2045/0085; B64D 2221/00

(57) ABSTRACT

The present invention relates to a system (40) for redistributing power in an aircraft with at least two electrical powertrain units (10), each powertrain unit (10) comprises a propulsion unit (15) powered by an energy storage unit (13); and a control system (41) configured to monitor operating status of each propulsion unit (15) and each energy storage unit (13); identify a malfunctioning unit (A-D) from the group of propulsion units (15) and energy storage units (13); and control at least one set of reconfiguration switches (28; 38; 48; 58) to disconnect the identified malfunctioning unit (A-D) from the system and to reroute power from one or more energy storage units (13) to one or more propulsion units (15). The system also comprises an auxiliary power supply (32) configured to provide extra power to the system, the control system being configured to —receive status information from the auxiliary power supply (32); —control the operation of the auxiliary power supply (32), and —provide power from the auxiliary power supply (32) to one or more of the propulsion units (15) by controlling the at least one set of reconfiguration switches (28; 38; 48; 58), wherein the auxiliary power supply comprises a turbogenerator (52) supplying DC power to the system via a rectifier (53), when connected. The invention also relates to a method for redistributing power in an aircraft.

### TECHNICAL FIELD

The present disclosure relates to a system for redistributing power in an aircraft (airplane) when one or more energy storage units and/or propulsion units malfunctions, e.g. during flight. The present disclosure also relates to a method for redistributing power in an aircraft.

### BACKGROUND

The propulsion system in an electrically powered airplane is a system that needs to be designed to maintain operation at all times. In order to reduce the risk of catastrophic failure during flight, a plurality of powertrain units (as disclosed in FIG. 1) may be provided, wherein each powertrain unit has a propulsion unit being powered by an energy storage unit, e.g. a battery.

However, if an airplane is designed to have four powertrain units and a malfunction occurs in one of the propulsion units and/or energy storage units during flight, the airplane will lose the propulsion provided by the powertrain unit where the malfunctioning unit is placed. This will have a direct impact on the performance of the propulsion system, even though parts of the malfunctioning powertrain unit still are operational.

### SUMMARY

Thus, there is a need to provide a system to discontinue using a malfunctioning unit (propulsion unit or energy storage unit of a powertrain) and re-allocate use of the part that is still operational to provide propulsion to the airplane during flight.

An object of the present disclosure is to provide a system which seeks to mitigate, alleviate, or eliminate one or more of the above-identified deficiencies in the art and disadvantages singly or in any combination and to provide a method for redistributing power in an aircraft.

This object is obtained by a system for redistributing power in an aircraft with at least two electrical powertrain units, each powertrain unit comprises a propulsion unit powered by an energy storage unit, wherein the system further comprises a control system configured to monitor operating status of each propulsion unit and each energy storage unit; identify a malfunctioning unit from the group of propulsion units and energy storage units; and control at least one set of reconfiguration switches to disconnect the identified malfunctioning unit from the system and to reroute power from one or more energy storage units to one or more propulsion units.

According to a first aspect, the control system is further configured to control the at least one set of reconfiguration switches in order to connect at least one energy storage unit and at least one propulsion unit to at least one common DC bus.

According to a second aspect, the system further comprise an auxiliary power supply configured to provide extra power to the system, wherein the control system is configured to: receive status information from the auxiliary power supply, control the operation of the auxiliary power supply, and provide power from the auxiliary power supply to one or more of the propulsion units by controlling the at least one set of reconfiguration switches. The auxiliary power supply may comprise a turbogenerator supplying DC power to the system via a rectifier, when connected.

This object is also obtained by a method for redistributing power in an aircraft with at least two electrical powertrain units, each powertrain unit comprises a propulsion unit powered by an energy storage unit, wherein the system further comprises a control system configured to perform the steps of monitoring operating status of each propulsion unit and each energy storage unit; identifying a malfunctioning unit from the group of propulsion units and energy storage units; and controlling at least one set of reconfiguration switches to disconnect the identified malfunctioning unit from the system and to reroute power from one or more energy storage units to one or more propulsion units. The system may further comprise an auxiliary power supply configured to provide extra power to the system, wherein the control system is further configured to perform the step of: receiving status information from the auxiliary power supply; controlling the operation of the auxiliary power supply, and providing power from the auxiliary power supply to one or more of the propulsion units by controlling the at least one set of reconfiguration switches, wherein the auxiliary power supply may comprise a turbogenerator supplying DC power to the system via a rectifier, when connected.

An advantage with the present invention is that resources within a powertrain unit system, i.e. energy storage unit or propulsion unit, that are still operational may be used to provide propulsion even by disconnecting malfunctioning units and rerouting power.

Further aspects and advantages may be obtained by a skilled person from the detailed description.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates a prior art powertrain unit;

FIG. 2 illustrates a first embodiment of a system for redistributing power;

FIG. 3 illustrates a second embodiment of a system for redistributing power with an auxiliary power supply;

FIG. 4 illustrates a third embodiment of a system for redistributing power with an auxiliary power supply and a common DC bus;

FIG. 5 illustrates a fourth embodiment of a system for redistributing power with two subsystems (one for each side of an aircraft).

FIG. 6 illustrates a fifth embodiment of a system for redistributing power with two subsystems and two auxiliary power supplies (one for each side of an aircraft) and a distributed control system.

FIG. 7 is a flow chart illustrating a method for redistributing power in an aircraft.

### DETAILED DESCRIPTION

Aspects of the present disclosure will be described more fully hereinafter with reference to the accompanying drawings. The system and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

Some of the example embodiments presented herein are directed towards a system and a method for redistributing energy reserves by distributing power in an aircraft.

The aircraft may for example be one or more of: an airplane, a fixed-wing aircraft, a conventional or short take-off and landing (CTOL or STOL) aircraft, a monoplane, and adapted to be flown by a pilot on board the aircraft. The aircraft or airplane may for example comprise one or more of: (braced) wings, a fuselage, an empennage, a cockpit, a passenger cabin, flight control surfaces (such as ailerons, elevators, a rudder, flaps, air brakes, etc.), and a (wheeled and/or retractable) landing gear.

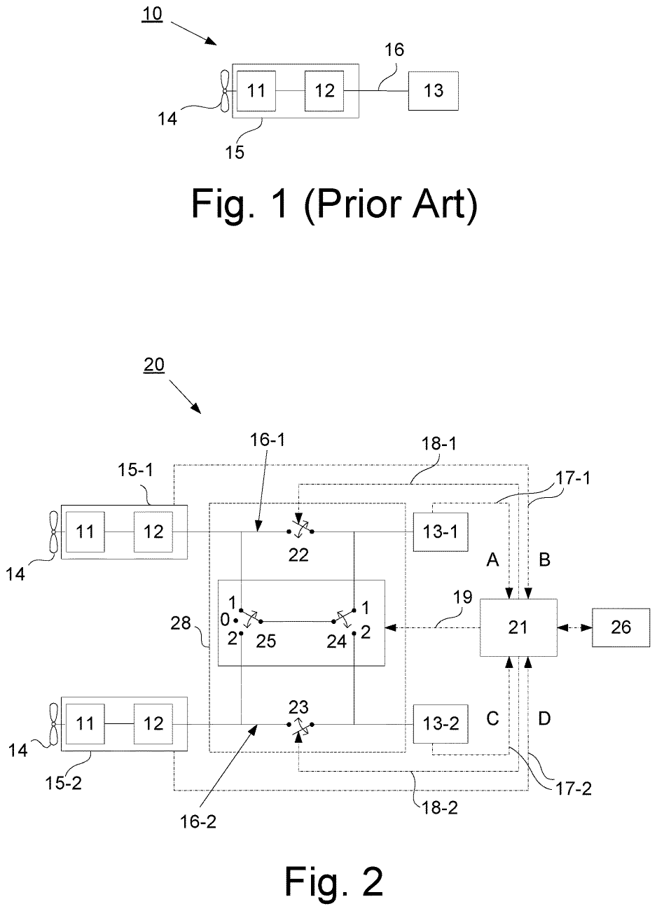

FIG. 1 illustrates a powertrain unit 10 according to prior art. The powertrain unit 10 comprises a propulsion unit 15 and an energy storage unit 13, wherein the propulsion unit is powered by the energy storage unit 13 via a local direct current, DC, bus, 16. The propulsion unit 15 comprises an alternating current, AC, motor 11 and a DC/AC inverter 12, and the motor 11 is mechanically connected to a propeller 14. The energy storage unit 13 may be any type of unit configured to store electric energy, e.g. a battery. The DC bus 16 may comprise one or more power/feeding lines, and as an example one power/feeding line may be connected to a positive terminal of the energy storage unit 13 and one power/feeding line may be connected to a negative terminal of the energy storage unit 13. However, in order to simplify the drawings, a single line 16 is provided to illustrate the local DC bus within each powertrain unit 10 in the example embodiments.

In the description in connection with FIGS. 2-6, switches are used to reconfigure the interconnection network between propulsion units and energy storage units (as well as auxiliary power supplies when such are available in the system). Each switch is configured to open and close the connection in a DC bus configuration to connect/disconnect an energy storage unit or propulsion unit from the feeding/power line, but for simplicity only one switch is illustrated to control the connection in the DC busses below.

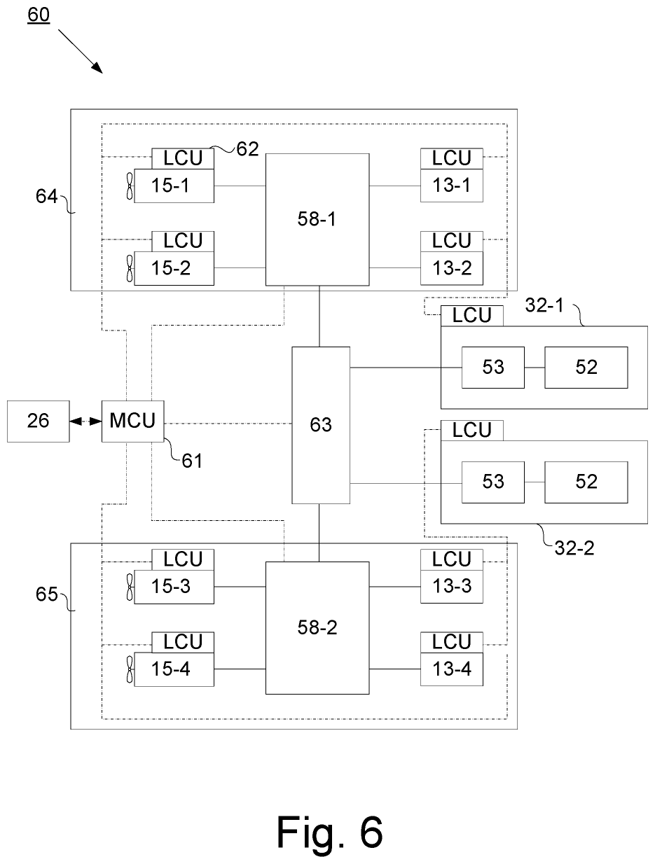

FIG. 2 illustrates a first embodiment of a system 20 for redistributing power in an aircraft comprising two powertrain units, each comprising an energy storage unit 13-1, 13-2 (commonly denoted 13) and a propulsion unit 15-1, 15-2 (commonly denoted 15) connected via a local DC bus 16-1, 16-2 (commonly denoted 16). Each propulsion unit 15 comprises an alternating current, AC, motor 11 and a DC/AC inverter 12, and the motor 11 is mechanically connected to a propeller 14. In some examples, the AC motor 11 is an induction motor and the DC/AC inverter is a variable frequency inverter. The energy storage unit 13 may be any type of unit configured to store electric energy, e.g. a battery or battery pack. The system further comprises a control system 21 configured to monitor operating status of each propulsion unit 15-1, 15-2 and each energy storage unit 13-1, 13-2 via a signal feed, which is illustrated by the dash-dotted lines 17-1, 17-2 (commonly denoted 17). The signal feed provides information relating to the operating status of the propulsion units and energy storage units to the control system 21. The control system may be a single control unit (as illustrated in FIGS. 2, 3, 4 and 5) or a distributed control system (as illustrated in FIG. 6).

The control unit 21 is further configured to identify a malfunctioning unit (a signal indicating a malfunctioning unit has been detected is illustrated by A-D in FIG. 2) from the group of propulsion units 15 and energy storage units 13 in the system via the signal feeds 17; and to control a set of reconfiguration switches 28 to disconnect the identified malfunctioning unit from the system and to reroute power from one or more energy storage units 13 to one or more propulsion units 15. In the illustrated example, control unit 21 monitors energy storage unit 13-1 via A (17-1), propulsion unit 15-1 via B (17-1), energy storage unit 13-2 via C (17-2), propulsion unit 15-2 via D (17-2). While A-D and 17-1, 17-2 are illustrated separately for purposes of clarity, in some embodiments control unit 21 is connected to and monitors the energy storage units 13 and propulsion units 15 via a common digital network, such as a CANaerospace or ARINC network, and A-D comprise messages on the digital network. “Malfunctioning”, as used herein, includes a failure of a unit and any operating condition that requires stopping use of the unit to maintain aircraft safety or to avoid damage to the unit.

Each switch in the set of reconfiguration switches 28 comprises in this embodiment disconnect switches 22, 23 are configured to connect/disconnect the energy storage unit 13 from the respective propulsion unit 15 in each powertrain unit by closing or opening the switch 22, 23 arranged in the local DC-bus 16-1, 16-2 provided rerouting switches 24, 25 are not bypassing a disconnect switch. The control system 21 is configured to control the position of the disconnect switch 22, 23 as illustrated by 18-1, 18-2 and isolate any identified malfunctioning unit A-D. Furthermore, the set of reconfiguration switches 28 also comprises rerouting switches 24, 25 arranged between the local DC busses 16-1, 16-2 of the powertrain units. Specifically, the rerouting switches may comprise a first rerouting switch 24 arranged between the powertrain units 10 upstream of the disconnect switch 22, 23 in each powertrain unit 10 and a second rerouting switch 25 arranged between the powertrain units 10 downstream of the disconnect switch 22, 23 in each powertrain unit 10. “Upstream”, as used herein, may be construed as on the side of the disconnect switch 22, 23 closest to the energy storage units 13. “Downstream”, as used herein, may be construed as on the side of the disconnect switch 22, 23 closest to the propulsion units 15. The rerouting switches 24, 25 are in this embodiment controlled by a control signal, as illustrated by line 19, whereby first rerouting switch 24 may be set in at least two positions “1” or “2” and second rerouting switch 25 may be set in three positions “0”, “1” or “2” dependent on the malfunctioning unit, where “0” is the neutral position during normal operations to prevent unintentional bypassing of an open disconnect switch 22, 23. A neutral position “0” (not shown) may also be implemented in rerouting switch 24 to increase safety.

This is illustrated by Table 1 below:

TABLE 1

| Malfunctioning | | | | |
|---|---|---|---|---|
| unit | Switch 22 | Switch 23 | Switch 24 | Switch 25 |
| None | Closed | Closed | N/A | Position “0” |
| A | Open | Closed | Position “2” | Position “1” |
| B | Open | Closed | Position “1” | Position “2” |
| C | Closed | Open | Position “1” | Position “2” |
| D | Closed | Open | Position “2” | Position “1” |

During normal operation, the control unit 21 sets the disconnect switches 22, 23 in a closed position, the rerouting switch 24 in any position (as indicated by N/A or in neutral, position “0”, if available) and rerouting switch 25 in position “0”.

### Example 1

When the energy storage unit 13-1 malfunctions, the control system 21 receives information that “A” is malfunctioning and in response to this information, the control unit sets the disconnect switch 22 in an open position while maintaining disconnect switch 23 in a closed position, and the rerouting switch 24 is set in position “2” and the rerouting switch 25 in position “1” to connect the energy storage unit 13-2 to propulsion unit 15-1. Thus, energy storage unit 13-2 is powering both propulsion units 15-1 and 15-2.

### Example 2

When the propulsion unit 15-2 malfunctions, the control system 21 receives information that “D” is malfunctioning and in response to this information, the control unit sets the disconnect switch 23 in an open position while maintaining disconnect switch 22 in a closed position, and the rerouting switch 24 is set in position “2” and the rerouting switch 25 in position “1” to connect the energy storage unit 13-2 to propulsion unit 15-1. Thus, both energy storage units 13-1 and 13-2 are powering the propulsion unit 15-1.

The system also comprises an avionics system 26 that is configured to communicate with and to provide instructions to the control system 21, especially when a malfunctioning unit A-D has been identified. The instructions may be manually activated by the pilot or may be automatically generated by the avionics system 26.

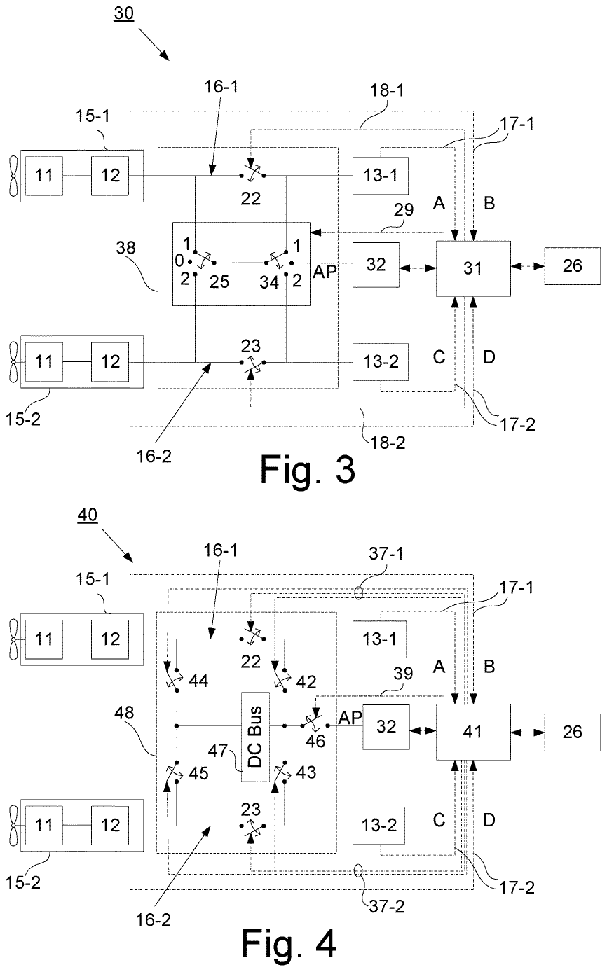

FIG. 3 illustrates a second embodiment of a system 30 for redistributing power in an aircraft, e.g. during flight. The system 30 is similar to the system described in connection with FIG. 2 with the addition of an auxiliary power supply 32 and replacing the control system with a control system 31 with additional functionality together with an updated set of reconfiguration switches 38 where the two-way rerouting switch 24 in FIG. 2 is replaced by a three-way rerouting switch 34. As such, the three-way rerouting switch 34 may be a first rerouting switch 34 arranged between the powertrain units 10 upstream of the disconnect switch 22, 23 in each powertrain unit 10. The rerouting switch 34 has one additional position “AP” (Auxiliary Power) to which the auxiliary power supply 32 is connected. A neutral position “0” (not shown) may also be implemented in rerouting switch 34 to increase safety.

The auxiliary power supply 32 is configured to provide power to the system if needed and the control system 31 is configured to:
receive status information from the auxiliary power supply 32;
control the operation of the auxiliary power supply 32, and
provide power from the auxiliary power supply 32 to one or more of the propulsion units 15 by controlling the set of reconfiguration switches 38.

The rerouting switches 34, 25 are in this embodiment controlled by a control signal from the control system 31, as illustrated by line 29, whereby first rerouting switch 34 may be set in three positions “AP”, “1” or “2” and second rerouting switch 25 may be set in three positions “0”, “1” or “2” dependent on the malfunctioning unit. In this example, the rerouting switch “34” is mutually exclusive to connect “AP” and “13-1” or “AP” and “13-2” as illustrated below in example 3.

This is illustrated by Table 2 below:

TABLE 2

| Malfunctioning | | | | |
|---|---|---|---|---|
| unit | Switch 22 | Switch 23 | Switch 24 | Switch 25 |
| None | Closed | Closed | N/A | Position “0” |
| A | Open | Closed | Position “AP” | Position “1” |
| B | Open | Closed | Position “1” | Position “2” |
| C | Closed | Open | Position “AP” | Position “2” |
| D | Closed | Open | Position “2” | Position “1” |

The auxiliary power supply is in this embodiment configured to provide power to the propulsion unit when the energy storage unit in that powertrain unit malfunctions, as well as providing extra power when required without any energy storage units malfunctions.

During normal operation, the control unit 31 sets the disconnect switches 22, 23 in a closed position, the rerouting switch 34 in any position (as indicated by N/A or in neutral, position “0”, if available) and rerouting switch 25 in position “0”.

### Example 3

When the energy storage unit 13-1 malfunctions, the control system 31 receives information that “A” is malfunctioning and in response to this information, the control unit sets the disconnect switch 22 in an open position while maintaining disconnect switch 23 in a closed position, and the rerouting switch 34 is set in position “AP” and the rerouting switch 25 in position “1” to connect the auxiliary power supply 32 to propulsion unit 15-1.

FIG. 4 illustrates a third embodiment of a system 40 for redistributing power with an auxiliary power supply and a common DC bus 47. As in the previously described embodiments, system 40 comprises two powertrain units, each comprising an energy storage unit 13-1, 13-2 and a propulsion unit 15-1, 15, 2 connected via a local DC bus 16-1, 16-2 provided rerouting switches 42-45 are not bypassing a disconnect switch. The system further comprises a control system 41 configured to monitor operating status of each propulsion unit 15-1, 15-2 and each energy storage unit 13-1, 13-2 via a signal feed, which is illustrated by the dash-dotted lines 17-1, 17-2. The signal feed provides information relating to the operating status of the propulsion units and energy storage units to the control system 41.

System 40 further comprises an auxiliary power supply 32, which is configured to provide power to the system if needed and the control system 41 is configured to:
receive status information from the auxiliary power supply 32;
control the operation of the auxiliary power supply 32, and
provide power from the auxiliary power supply 32 to one or more of the propulsion units 15 by controlling the set of reconfiguration switches 48.

The control unit 41 is further configured to identify a malfunctioning unit from the group of propulsion units 15 and energy storage units 13 in the system via the signal feeds 17; and to control a set of reconfiguration switches 48 to disconnect the identified malfunctioning unit from the system and to reroute power from one or more energy storage units 13 to one or more propulsion units 15.

Each switch in the set of reconfiguration switches 48 comprises in this embodiment disconnect switches 22, 23 configured to connect/disconnect the energy storage unit 13 from the respective propulsion unit 15 in each powertrain unit by closing or opening the switch 22, 23 arranged in the local DC-bus 16-1, 16-2. Furthermore, the set of reconfiguration switches 48 also comprises rerouting switches 42, 43, 44 and 45 arranged between the local DC busses 16-1, 16-2 of the powertrain units and the common DC bus 47 in order to selectively connect the energy storage units 13 and propulsion unit 15 to the common DC bus 47. Specifically, the rerouting switches may comprise first rerouting switches 42-43 arranged between the powertrain units 10 upstream of the disconnect switch 22, 23 in each powertrain unit 10 and second rerouting switches 44-45 arranged between the powertrain units 10 downstream of the disconnect switch 22, 23 in each powertrain unit 10.

The control system 41 is configured to control the position of the disconnect switch 22, 23 and the rerouting switches 42-45 as illustrated by 37-1, 37-2 and isolate any identified malfunctioning unit A-D. The set of reconfiguration switches may also comprise an auxiliary switch 46 controlled by a control signal, as illustrated by line 39, whereby the auxiliary power supply may be connected to the common DC bus 47 of the system 40.

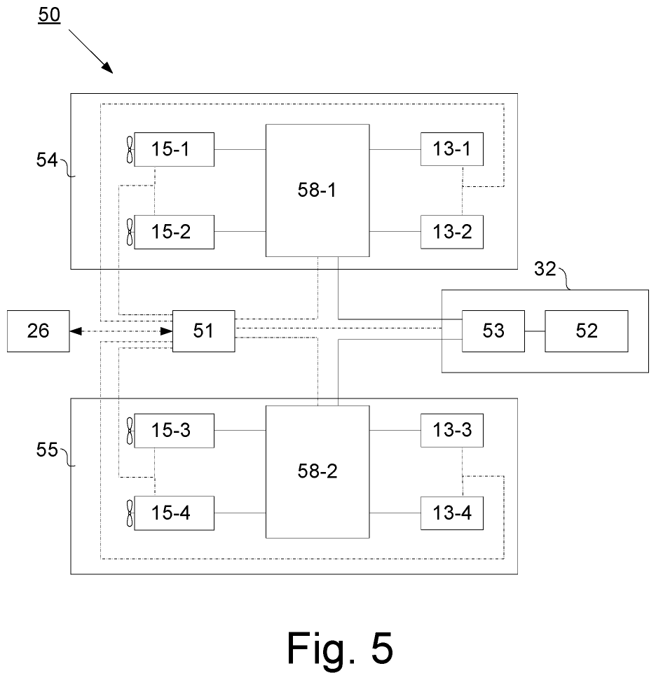

FIG. 5 illustrates a fourth embodiment of a system 50 for redistributing power with two subsystems 54 and 55, one subsystem for each side of an aircraft (not shown). In this example embodiment, each sub system comprises two powertrain units (each comprising a propulsion unit 15 and an energy storage unit 13) with a set of reconfiguration switches 58-1 and 58-2 (commonly denoted 58). Examples of reconfiguration switches have been described in connection with FIGS. 2-4.

The system 50 may also comprise an auxiliary power supply 32 that is shared between the subsystems 58, and in this example embodiment, the auxiliary power supply 32 comprises a turbogenerator 52 supplying DC power to the system via a rectifier 53, when connected. A control system 51 is provided to receive indicative status of the propulsion units 15 and the energy storage units 13 and identify any malfunctioning unit in both subsystems 54 and 55, as well as handle the auxiliary power supply 32 as described above. An avionics system 26 is also provided that communicates with and provides instructions to the control system 51.

FIG. 6 illustrates a fifth embodiment of a system 60 for redistributing power with two subsystems 64 and 65 and two auxiliary power supplies 32-1 and 32-2 (one auxiliary power supply for each side of an aircraft) and a distributed control system. The distributed control system comprises a master control unit, MCU, 61 and local control units, LCU, 62, wherein each LCU is configured to control operations in an energy storage unit 13, propulsion unit 15 and/or auxiliary power supply 32. The two sets of reconfiguration switches 58 are connected to an interconnecting network 63 configured to create an interconnecting DC bus by activating interconnecting switches (not shown) wherein the auxiliary power supplies 32-1 and 32-2 may be connected to the interconnecting DC bus based on the control signals provided by the MCU 61. Each LCU 62 controlling an energy storage unit 13 may be configured to control contactors to connect and disconnect the energy storage unit 13 from the system. The MCU 61 may be configured to communicate with the LCUs 62, which is illustrated by the dash-dotted lines in FIG. 6.

### Example 4

If energy storage unit 13-2 malfunctions, it is disconnected from the system (e.g. by the LCU controlling the energy storage unit) and one of the auxiliary power supplies (e.g. 32-1) is connected to the propulsion unit 15-2 in the first subsystem 64 via the interconnecting DC bus via interconnecting switches (not shown) within the interconnecting network 63 and the set of configuration switches 58-1. For instance, if the example embodiment illustrated in FIG. 4 is used then the interconnecting DC bus may be connected, by activating the interconnecting switches (not shown), to the common DC bus 47 inside the set of reconfiguration switches 48.

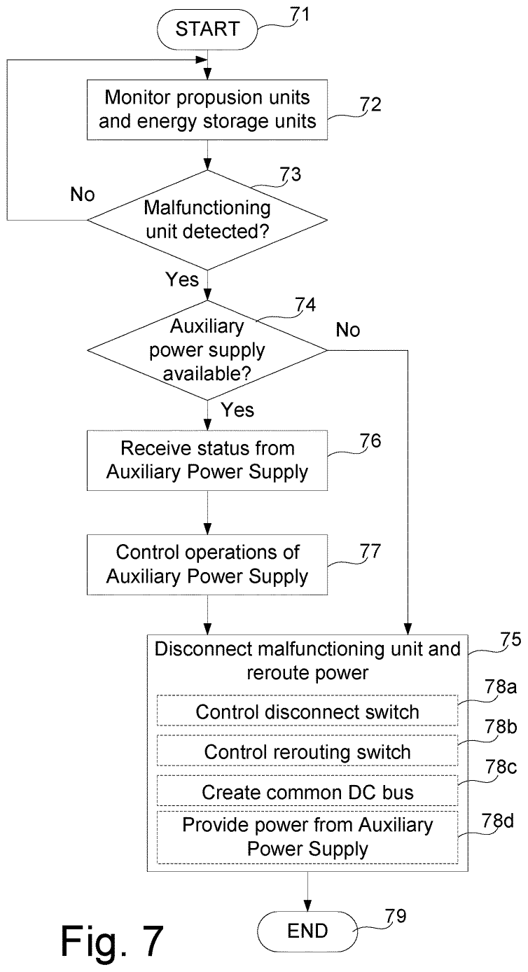

FIG. 7 is a flow chart illustrating a method for redistributing power in an aircraft with at least two electrical powertrain units 10, each powertrain unit 10 comprises a propulsion unit 15 powered by an energy storage unit 13, wherein the system further comprises a control system configured to perform the method.

The flow starts in 71, and in step 72 the control system monitors operating status of each propulsion unit 15 and each energy storage unit 13. This may be done by receiving a status update from each unit a regular interval. In the next step 73, the control system identifies a malfunctioning unit from the group of propulsion units 15 and energy storage units 13. The control system thereafter may perform an optional step 74, in which the control system checks if there is an auxiliary power supply available. In some systems, no auxiliary power supply is available (as illustrated in FIG. 2) and then this step may be omitted.

If no auxiliary power supply is available, then the flow continues to step 75 in which the control system controls at least one set of reconfiguration switches to disconnect the identified malfunctioning unit from the system and to reroute power from one or more energy storage units 13 to one or more propulsion units 15.

Step 75 may comprise several steps and in a first option, provided the at least one set of reconfiguration switches further comprises disconnect switches and/or rerouting switches, the step of controlling the at least one set of reconfiguration switches further comprises the step of controlling 78a the disconnect switch arranged between the energy storage unit and the propulsion unit in each power train; and/or the step of controlling 78b the rerouting switches arranged between the at least two powertrain units. Another option also includes the possibility for the control system to perform the step of controlling 78c the at least one set of reconfiguration switches in order to connect at least one energy storage unit and at least one propulsion unit to at least one common DC bus.

In case the system comprises an auxiliary power supply, the flow continues from step 74 to step 76, where the control system is further configured to perform the step of receiving status information from the auxiliary power supply. In step 77, the control system is configured to perform the step of controlling the operation of the auxiliary power supply. The flow thereafter continues to step 75, where an optional step 78d is available due to the present of the auxiliary power supply, wherein the control is configured to provide power from the auxiliary power supply to one or more of the propulsion units by controlling the at least one set of reconfiguration switches. The flow ends in step 79.

The present disclosure relates to a system for redistributing power in an aircraft with at least two electrical powertrain units and a control system. Each powertrain unit comprises a propulsion unit and an energy storage unit, wherein the propulsion unit is powered by the energy storage unit. In normal operation, power from the energy storage unit of one powertrain unit is not applied to the other powertrain unit. The control system is configured to:
monitor operating status of each propulsion unit and each energy storage unit
identify a malfunctioning unit from the group of propulsion units and energy storage units, and
control at least one set of reconfiguration switches to disconnect the identified malfunctioning unit from the system and to reroute power from one or more energy storage units to one or more propulsion units.

According to some embodiments, the at least one set of reconfiguration switches comprises at least one disconnect switch arranged between the energy storage unit and the propulsion unit in each powertrain unit.

According to some embodiments, the at least one set of reconfiguration switches comprises rerouting switches arranged between the at least two powertrain units.

According to some embodiments, the control system is further configured to control the at least one set of reconfiguration switches in order to connect at least one energy storage unit and at least one propulsion unit to at least one common DC bus. If an auxiliary power supply is provided, the auxiliary power supply may be connected to the common DC bus.

According to some embodiments, the system further comprises an auxiliary power supply, e.g. a turbogenerator via a rectifier, which is configured to provide extra power to the system, wherein the control system is configured to:
receive status information from the auxiliary power supply,
control the operation of the auxiliary power supply, and
provide power from the auxiliary power supply to one or more of the propulsion units by controlling the at least one set of reconfiguration switches.

According to some embodiments, the at least one set of reconfiguration switches comprises at least one auxiliary switch, which is controlled by the control system to connect the auxiliary power supply to the system.

According to some embodiments, the control system comprises a master control unit, MCU, and local control units, LCU, wherein each LCU is configured to control operations in an energy storage unit and/or propulsion unit. If one or more auxiliary power supplies are provided, an LCU may be provided to control operations in each auxiliary power supply.

According to some embodiments, the system further comprises an avionics system configured to communicate with and to provide instructions to the control system when a malfunctioning unit has been identified. Instructions may be manually by the pilot or automatically by the avionics system.

According to some embodiments, the rerouting switches comprise at least one first rerouting switch upstream of the at least one disconnect switch in each powertrain unit and at least one second rerouting switch downstream of the at least one disconnect switch in each powertrain unit. It should be noted that this example embodiment may be implemented without the above-mentioned auxiliary power supply.

The present disclosure further relates to a method for redistributing power in an aircraft with at least two electrical powertrain units and a control system. Each powertrain unit comprises a propulsion unit and an energy storage unit, wherein the propulsion unit is powered by the energy storage unit. The control system is configured to perform the steps of:
monitoring operating status of each propulsion unit and each energy storage unit,
identifying a malfunctioning unit from the group of propulsion units and energy storage units, and
controlling at least one set of reconfiguration switches to disconnect the identified malfunctioning unit from the system and to reroute power from one or more energy storage units to one or more propulsion units.

According to some embodiments, the at least one set of reconfiguration switches further comprises disconnect switches and/or rerouting switches; and the step of controlling the at least one set of reconfiguration switches further comprises:
controlling the disconnect switch arranged between the energy storage unit and the propulsion unit in each power train, and/or
controlling the rerouting switches arranged between the at least two powertrain units.

According to some embodiments, the control system is further configured to perform the step of controlling the at least one set of reconfiguration switches in order to connect at least one energy storage unit and at least one propulsion unit to at least one common DC bus.

According to some embodiments, the system further comprises an auxiliary power supply configured to provide extra power to the system, wherein the control system is further configured to perform the step of:
receiving status information from the auxiliary power supply,
controlling the operation of the auxiliary power supply, and
providing power from the auxiliary power supply to one or more of the propulsion units by controlling the at least one set of reconfiguration switches.

The present disclosure further relates to a computer program for redistributing power in an aircraft, comprising instructions which, when executed on at least one processor, cause the at least one processor to carry out the method according to any of the embodiments identified above. The present disclosure further relates to a computer-readable storage medium carrying a computer program for redistributing power in an aircraft according to any of the embodiments identified above.

The present disclosure further relates to an aircraft comprising a system according to any of the embodiments identified above. The present disclosure further relates to an aircraft comprising a system according to some embodiments for redistributing power with two subsystems, one subsystem for each side of the aircraft, wherein each subsystem comprises two powertrain units with a set of reconfiguration switches, each powertrain unit comprising a propulsion unit and an energy storage unit, wherein the system comprises two auxiliary power supplies, one auxiliary power supply for each side of the aircraft, and wherein the two sets of reconfiguration switches are connected to an interconnecting network configured to create an interconnecting DC bus by activating interconnecting switches, and wherein the auxiliary power supplies are connectable to the interconnecting DC bus based on control signals provided by the MCU.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A system (20; 30; 40; 50; 60) for redistributing power in an aircraft, the system comprising at least two electrical powertrain units (10), each powertrain unit (10) comprises a propulsion unit (15) powered by an energy storage unit (13), wherein the system further comprises a control system (21; 31; 41; 51; 61) configured to:
monitor operating status of each propulsion unit (15) and each energy storage unit (13);
identify a malfunctioning unit from the group of propulsion units (15) and energy storage units (13); and
control at least one set of reconfiguration switches (28; 38; 48; 58) to disconnect the identified malfunctioning unit from the system and to reroute power from one or more of the energy storage units (13) to one or more propulsion units (15),
the system further comprising an auxiliary power supply (32) configured to provide extra power to the system, wherein the control system (31; 41:51; 61) is configured to:
receive status information from the auxiliary power supply (32);
control the operation of the auxiliary power supply (32), and
provide power from the auxiliary power supply (32) to one or more of the propulsion units (15) by controlling the at least one set of reconfiguration switches (38; 48; 58),
wherein the auxiliary power supply comprises a turbogenerator (52) supplying DC power to the system via a rectifier (53), when connected.

2. The system according to claim 1, wherein the at least one set of reconfiguration switches (28; 38; 48) comprises at least one disconnect switch (22, 23) arranged between the energy storage unit (13) and the propulsion unit (15) in each powertrain unit (10).

3. The system according to claim 1, wherein the at least one set of reconfiguration switches (28; 38; 48) comprises rerouting switches (24,25; 34; 42-45) arranged between the at least two powertrain units (10).

4. The system according to claim 1, wherein the control system (41) is further configured to control the at least one set of reconfiguration switches (48) in order to connect at least one energy storage unit (13) and at least one propulsion unit (15) to at least one common DC bus (47).

5. The system according to claim 1, wherein the at least one set of reconfiguration switches (48) comprises at least one auxiliary switch (46) which is controlled by the control system (41) to connect the auxiliary power supply (32) to the system (40).

6. The system according to claim 1, wherein the auxiliary power supply (32) is connected to the common DC bus (47).

7. The system according to any of claims 1-6, wherein the control system (60) comprises a master control unit, MCU, (61) and local control units, LCU, (62), wherein each LCU is configured to control operations in an energy storage unit (13), propulsion unit (15) and/or auxiliary power supply (32).

8. The system according to claim 1, further comprising an avionics system (26) configured to communicate with and to provide instructions to the control system (21; 31; 41; 51; 61) when a malfunctioning unit has been identified.

9. The system according to claim 2, wherein the rerouting switches comprise at least one first rerouting switch (24; 34; 42-43) upstream of the at least one disconnect switch (22, 23) in each powertrain unit (10) and at least one second rerouting switch (25; 44-45) downstream of the at least one disconnect switch (22, 23) in each powertrain unit (10).

10. A method for redistributing power in an aircraft with a system comprising at least two electrical powertrain units (10), each powertrain unit (10) comprises a propulsion unit (15) powered by an energy storage unit (13), wherein the system further comprises a control system (21; 31; 41; 51) configured to perform the steps of:
monitoring (72) operating status of each propulsion unit (15) and each energy storage unit (13);
identifying (73) a malfunctioning unit (A-D) from the group of propulsion units (15) and energy storage units (13); and
controlling (75) at least one set of reconfiguration switches (28; 38; 48; 58) to disconnect the identified malfunctioning unit (A-D) from the system and to reroute power from one or more of the energy storage units (13) to one or more propulsion units (15),
wherein the system further comprises an auxiliary power supply configured to provide extra power to the system, wherein the control system is further configured to perform the step of:
receiving (76) status information from the auxiliary power supply;
controlling (77) the operation of the auxiliary power supply, and
providing power (78d) from the auxiliary power supply to one or more of the propulsion units by controlling the at least one set of reconfiguration switches,
wherein the auxiliary power supply comprises a turbogenerator (52) supplying DC power to the system via a rectifier (53), when connected.

11. The method according to claim 10, wherein the at least one set of reconfiguration switches further comprises disconnect switches and/or rerouting switches; and the step of controlling the at least one set of reconfiguration switches further comprises:
controlling (78a) the disconnect switch arranged between the energy storage unit and the propulsion unit in each power train; and/or
controlling (78b) the rerouting switches arranged between the at least two powertrain units.

12. The method according to claim 10, wherein the control system is further configured to perform the step of controlling (78c) the at least one set of reconfiguration switches in order to connect at least one energy storage unit and at least one propulsion unit to at least one common DC bus.

13. A computer program for redistributing power in an aircraft, comprising instructions which, when executed on at least one processor, cause the at least one processor to carry out the method according to any of claim 10.

14. A computer-readable storage medium carrying a computer program for redistributing power in an aircraft according to claim 13.

15. An aircraft comprising a system (60) according to claim 7 for redistributing power with two subsystems (64, 65), one subsystem for each side of the aircraft, wherein each subsystem comprises two powertrain units with a set of reconfiguration switches (58-1, 58-2), each powertrain unit comprising a propulsion unit (15) and an energy storage unit (13), wherein the system (60) comprises two auxiliary power supplies (32-1, 32-2), one auxiliary power supply for each side of the aircraft, and wherein the two sets of reconfiguration switches (58-1, 58-2) are connected to an interconnecting network (63) configured to create an interconnecting DC bus by activating interconnecting switches, and wherein the auxiliary power supplies (32-1, 32-2) are connectable to the interconnecting DC bus based on control signals provided by the MCU (61).
